(19) United States
(12) Patent Application Publication
(10) Pub. No.: US 2011/0181947 A1
(43) Pub. Date: Jul. 28, 2011

(54) MICROSCOPE INSPECTION DEVICE FOR FLUORESCENCE INSPECTIONS

(75) Inventor: Chih-Yi Yang, Taipei City (TW)

(73) Assignee: Lumos Technology Co., Ltd.

(21) Appl. No.: 12/856,405

(22) Filed: Aug. 13, 2010

(30) Foreign Application Priority Data
Jan. 22, 2010 (TW) 099201409

(51) Int. Cl. G02B 21/06

(52) U.S. Cl. 359/385

(57) ABSTRACT

A microscope inspection device for performing a fluorescence inspection of a testing object includes a camera module, a microscope lens, a light source module, and a first light filter. The camera module includes an image sensor for sensing an image light of the testing object. The microscope lens has an end connected to the camera module and the microscope lens is used for amplifying the image light of the testing object. The light source module is connected to the microscope lens and emits a light of a first wavelength towards the testing object. The first light filter is installed at another end of the microscope lens and provided for allowing a light of a second wavelength only to pass through the microscope lens.

### FIELD OF THE INVENTION

The present invention generally relates to an optical inspection device, in particular to a microscope inspection device for fluorescence inspections.

### BACKGROUND OF THE INVENTION

Since phosphor has the features of absorbing a light of a specific wavelength and emitting a light of another specific wavelength, therefore fluorescence inspections is used increasingly more extensive for various different inspection applications in the bio-medical field.

For example, fluorescent protein is introduced into a living organism for observing positions and a change of cancer cells in the living organism under a fluorescent light source, without requiring any dissection of the living organism. Fluorescence inspection not only improves the efficiency for researches, but also provides a more humanistic way for the research process. In addition, fluorescence inspection is commonly used for a counterfeit banknote inspection, a forensic bloodstain inspection, and an antique identification, etc.

Since most testing sample cannot be recognized or identified visually, therefore a fluorescence inspection generally uses a microscope to operate together with an external fluorescent light source. Due to the weight and volume of the microscope, users usually do not bring the microscope to the spot for inspecting or testing the sample. In addition, it is necessary to fix a general external fluorescent light source to a position with respect to the sample and the microscope in order to obtain a clear sample image through the microscope. Obviously, such application is not convenient.

In view of the shortcoming of the conventional fluorescence inspections, there is a need to design a portable microscope inspection device for the fluorescence inspections, such that users no longer need to fix the fluorescent light source to a position with respect to the sample and the microscope, and the device can improve the efficiency of the inspection.

### SUMMARY OF THE INVENTION

Therefore, it is a primary objective of the present invention to provide a portable microscope inspection device for fluorescence inspections, such that users need not to fix the position of the device with respect to the fluorescent light source and the sample.

To achieve the foregoing objective, the present invention discloses a microscope inspection device for fluorescence inspections of a testing object, and the microscope inspection device for fluorescence inspections comprises a camera module, a microscope lens, a light source module, and a first light filter. The camera module includes an image sensor for sensing an image light of the testing object. An end of the microscope lens is coupled to the camera module, and the microscope lens is provided for amplifying the image light of the testing object. The light source module is coupled to the microscope lens, and emits a light of a first wavelength towards the testing object. The first light filter is installed at another end of the microscope lens, and provided for allowing a light of a second wavelength only to pass through the microscope lens.

### BRIEF DESCRIPTION OF THE DRAWINGS

FIG. 1 is an exploded view of a microscope inspection device for fluorescence inspections in accordance with the present invention; and

FIG. 2 is a cross-sectional view of a microscope inspection device for fluorescence inspections in accordance with the present invention.

### DESCRIPTION OF THE PREFERRED EMBODIMENTS

The technical characteristics and contents of the present invention will become apparent with the following detailed description accompanied with related drawings.

The present invention provides a microscope inspection device for fluorescence inspections of a testing object (not shown in the figure), and the testing object has a phosphor capable of absorbing a light of a first wavelength and emitting a light of a second wavelength, wherein the first wavelength is smaller than the second wavelength.

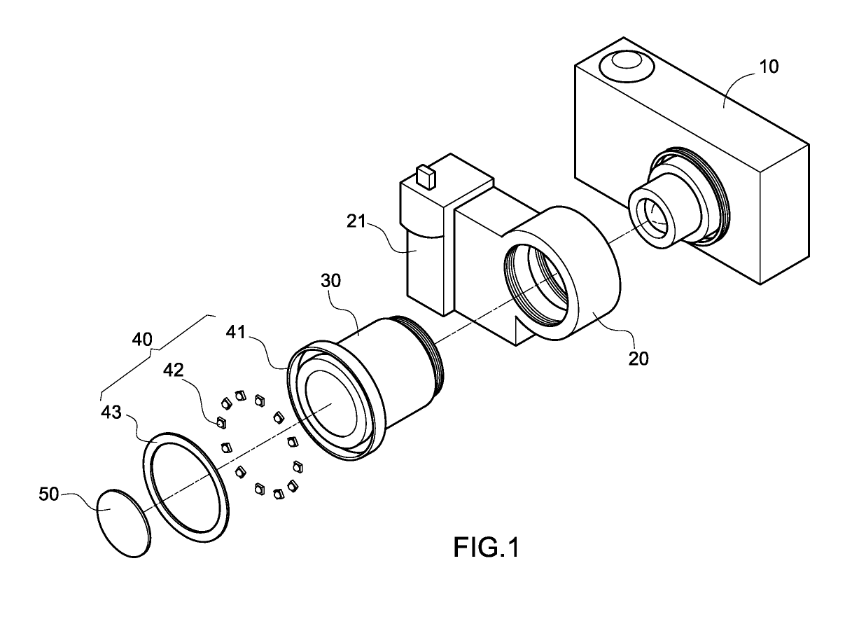

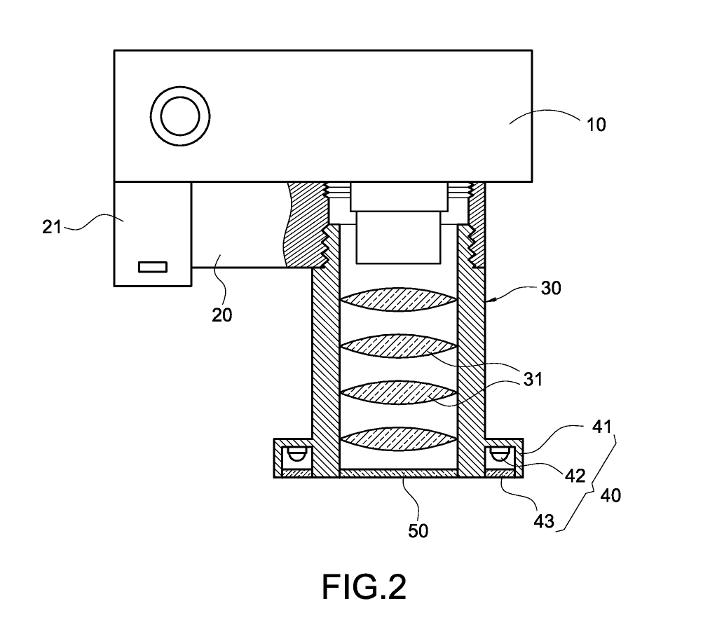

With reference to FIGS. 1 and 2, the microscope inspection device for fluorescence inspections comprises a camera module 10, an adapter 20, a microscope lens 30, a light source module 40, and a first light filter 50.

The camera module 10 comprises an image sensor (not shown in the figure) for sensing the image light of the testing object. In this preferred embodiment, the camera module 10 is a digital camera. The invention is not limited to such arrangement only, but the camera module 10 can be any camera device, such as an imaging module of a mobile phone or a personal digital assistant (PDA).

The adapter 20 is provided for adapting the microscope lens 30 onto the camera module 10, and the adapter 20 includes a power supply unit 21 for supplying electric power to the light source module 40. For example, the power supply unit 21 comprises at least one battery.

An end of the microscope lens 30 is connected onto the camera module 10 through the adapter 20 and provided for amplifying the image light of the testing object. The microscope lens 30 includes optical components 31 such as a plurality of lenses installed in the microscope lens 30.

The light source module 40 in a circular shape is coupled to a front end of the microscope lens 30 and disposed around the microscope lens 30. The light source module 40 comprises a circular containing base 41, and a plurality of light emitting diodes 42. The light emitting diodes 42 of the light source module 40 can emit light of a first wavelength towards the testing object.

The first light filter 50 is installed at another end of the microscope lens 30 and provided for allowing a light of a second wavelength to pass through the microscope lens 30. More specifically, the first light filter 50 is a band-pass filter.

With the light of the first wavelength emitted from the light source module 40 is projected onto the testing object, the fluorescence of the light of a second wavelength is induced by the phosphor in the testing object. And the light of a second wavelength passes into the microscope lens 30 through the first light filter 50, such that the camera module 10 can receive the image of the testing object. Therefore, the microscope inspection device for fluorescence inspections in accordance with the present invention is portable and no longer needs to fix the relative positions of the sample and the microscope for the fluorescent light source, so as to enhance the efficiency of the inspection.

To improve the recognition of the testing object by the camera module 10, the light source module 40 further comprises a second light filter 43 for filtering a light of a first wavelength emitted by the light emitting diodes. Preferably, the second light filter 43 is also in a circular shape to match the shape of the circular containing base 41.

While the invention has been described by means of specific embodiments, numerous modifications and variations could be made thereto by those skilled in the art without departing from the scope and spirit of the invention set forth in the claims.

What is claimed is:

1. A microscope inspection device for the fluorescence inspections, used for performing fluorescence inspections of a testing object, and the microscope inspection device for the fluorescence inspections comprising:
a camera module, having an image sensor for sensing an image light of the testing object;
a microscope lens, having an end coupled to the camera module, for amplifying the image light of the testing object;
a light source module, coupled to the microscope lens, for emitting a light of a first wavelength towards the testing object; and
a first light filter, installed at another end of the microscope lens, and provided for allowing a light of a second wavelength only to pass through the microscope lens.

2. The microscope inspection device for fluorescence inspections as recited in claim 1, wherein the first wavelength is smaller than the second wavelength.

3. The microscope inspection device for fluorescence inspections as recited in claim 1, wherein the light source module is in a circular shape and disposed around the microscope lens.

4. The microscope inspection device for fluorescence inspections as recited in claim 3, wherein the light source module comprises at least one light emitting diode.

5. The microscope inspection device for fluorescence inspections as recited in claim 4, wherein the light source module further comprises a second light filter for filtering the light of the first wavelength emitted by the light emitting diode.

6. The microscope inspection device for fluorescence inspections as recited in claim 4, wherein the second light filter is in a circular shape.

7. The microscope inspection device for fluorescence inspections as recited in claim 1, further comprising an adapter, for adapting the microscope lens onto the camera module.

8. The microscope inspection device for fluorescence inspections as recited in claim 7, wherein the adapter comprises a power supply unit for supplying electric power to the light emitting unit.

9. The microscope inspection device for fluorescence inspections as recited in claim 1, wherein the first light filter is a band-pass filter.
